(19) United States
(12) Patent Application Publication
(10) Pub. No.: US 2009/0100519 A1
(43) Pub. Date: Apr. 16, 2009

(54) Installer detection and warning system and method

(75) Inventors: Lee Codel Lawson Tarbotton, Aylesbury (GB); Alex James Hinchliffe, Bucks (GB)

Correspondence Address: Zilka-Kotab, PC, P.O. BOX 721120, SAN JOSE, CA, 95172-1120, US

(73) Assignee: McAfee, Inc.

(21) Appl. No.: 11/907,668

(22) Filed: Oct. 16, 2007

(51) Int. Cl. G06F 11/30

(52) U.S. Cl. 726/23

(57) ABSTRACT

A user of a computer system is provided with warning of unexpected or covert installation attempts using a malware or anti-virus detection engine. Even though the files that are unexpectedly attempted to be installed may be legitimate, rather than malware, the malware detection software is modified or configured to detect the unexpected installation and provide the user with an opportunity to abort the installation. A method of controlling installation of software in a computer system comprises detecting an attempt to install software on the computer system, identifying the software that was attempted to be installed, taking an action in response to identifying the software that was attempted to be installed.

### BACKGROUND OF THE INVENTION

1. Field of the Invention

The present invention relates to detecting attempts by installation programs to install software, warning the user of such attempted installations, and allowing the user to select whether or not to allow such installations.

2. Description of the Related Art

A common operation in the everyday use of a computer system is the installation of new software applications or tools. There are many ways in which new software may be installed in a system, some legitimate, some not. Attempts to install illegitimate software, such as malware, will normally be detected by an Anti-Virus or Anti-Spyware solution and will be blocked. However, there are many software applications and tools that are legitimate, but which are unwanted or are unexpectedly or covertly installed, that is, installed without informing the user that they are being installed. Although some operating systems warn the user when the inbuilt installer engine is used, typically, these operating systems do not alert the user when a third party installer engine is used. Many common applications use third party engines, which bypass the inbuilt warning mechanism.

For example, when a user installs ITUNES®, by default QUICKTIME® is also installed. Some DIVX® codec installers install the GOOGLE® toolbar covertly. REALPLAYER® and ADOBE® attempt, by default, to install GOOGLE® and YAHOO® toolbars, respectively. Although these applications are legitimate, not malware, they may alter a system's performance, interact with other applications on the system, or otherwise be unwanted by the user.

A need arises for a technique by which a user can be warned when such an unexpected, unwanted, or covert installation attempt is made.

### SUMMARY OF THE INVENTION

The present invention provides a user of a computer system with warning of unexpected or covert installation attempts using a malware or anti-virus detection engine. Even though the files that are unexpectedly attempted to be installed may be legitimate, rather than malware, the malware detection software is modified or configured to detect the unexpected installation and provide the user with an opportunity to abort the installation.

A method of controlling installation of software in a computer system comprises detecting an attempt to install software on the computer system, identifying the software that was attempted to be installed, taking an action in response to identifying the software that was attempted to be installed. The attempt to install software on the computer system may be detected using malware detection software. The malware detection software may be modified or configured to detect the attempt to install software on the computer system. The software that was attempted to be installed may be identified by analyzing information relating to the attempted installation.

The analyzed information may comprise at least one of an installer package, a family of installer packages to which the installer package belongs, installer header data, links the installer package may make, data identifying the software that was attempted to be installed, and links the software that was attempted to be installed would make if it were installed. The action taken in response to identifying the software that was attempted to be installed may comprise notifying a user of the computer system of the attempt to install software on the computer system and accepting from the user of the computer system input indicating further action to be taken. The further action to be taken may comprise aborting the installation, allowing the installation, or allowing part of the installation and blocking part of the installation. The action taken in response to identifying the software that was attempted to be installed may comprise taking at least one predefined action. The predefined action to be taken may comprise aborting the installation, allowing the installation, or allowing part of the installation and blocking part of the installation.

### BRIEF DESCRIPTION OF THE DRAWINGS

The details of the present invention, both as to its structure and operation, can best be understood by referring to the accompanying drawings, in which like reference numbers and designations refer to like elements.

FIG. 1 is an exemplary block diagram of a computer system in which malware detection software is used to detect covert or unexpected installations.

FIG. 2 is an exemplary flow diagram of a process of detecting covert or unexpected installations.

### DETAILED DESCRIPTION OF THE INVENTION

The present invention provides a user of a computer system with warning of unexpected or covert installation attempts using a malware or anti-virus detection engine. Even though the files that are unexpectedly attempted to be installed may be legitimate, rather than malware, the malware detection software is modified or configured to detect the unexpected installation and provide the user with an opportunity to abort the installation.

A typical computer malware is a program or piece of code that is loaded onto a computer and/or performs some undesired actions on a computer without the knowledge or consent of the computer operator. The most widespread, well-known and dangerous type of computer malware are computer viruses, that is, programs or pieces of code that replicate themselves and load themselves onto other connected computers. This method of infection would not preclude the installation of other types of malware, such as trojans, which is a program that installs malicious software under the guise of doing something else, spyware, which is installed surreptitiously on a personal computer to intercept, monitor, or take partial control over the user's interaction with the computer, or other malware either. Once the virus, trojan, spyware, or other malware has been loaded onto the computer, it is activated and may proliferate further and/or damage the computer or other computers.

Along with the proliferation of computer viruses and other malware has come a proliferation of software to detect and remove such viruses and other malware. This software is generically known as anti-virus software or programs or malware detection software or programs. In order to detect a virus or other malicious program, malware detection software typically scans files stored on disk in a computer system, data that is being transferred or downloaded to a computer system, or that is being accessed on a computer system, and/or software that is running on the computer system, and compares the data or software being scanned with profiles that identify various kinds of malware. The malware detection software may then take corrective action, such as notifying a user or administrator of the computer system of the virus, isolating the file or data, deleting the file or data, halting execution of the running program, etc.

Typically, computer viruses are transmitted in infected executable files or files that contain macros. Executable files include executable code that is intended to be run on a computer system. Thus, anti-virus programs typically scan executable files in order to find viruses.

Installer programs are special-purpose programs that perform the steps needed to install other software on a computer system. Installer programs may perform functions such as copying files to the computer system, scanning or analyzing storage of the computer system to determine the presence or absence of prior installations, required software components, etc., scanning, analyzing, or modifying the operating system and/or related data of the computer system, etc. For example, in the MICROSOFT WINDOWS® operating system, the system registry may be affected, while in the MACINTOSH®, UNIX®, or LINUX® operating systems, other code or data related to the operating system may be affected. Malware detection software will typically scan installer program files and will monitor execution of the installer programs. Attempts to install illegitimate software, such as malware, will normally be detected by the malware detection software and will be blocked. However, there are many software applications and tools that are legitimate, but which are unwanted or which are unexpectedly or covertly installed, that is, installed without informing the user that they are being installed. Although some operating systems warn the user when the inbuilt installer engine is used, typically, these operating systems do not alert the user when a third party installer engine is used. Many common applications use third party engines, which bypass the inbuilt warning mechanism. The present invention uses malware detection software to detect the unexpected installation and provide the user with an opportunity to abort the installation

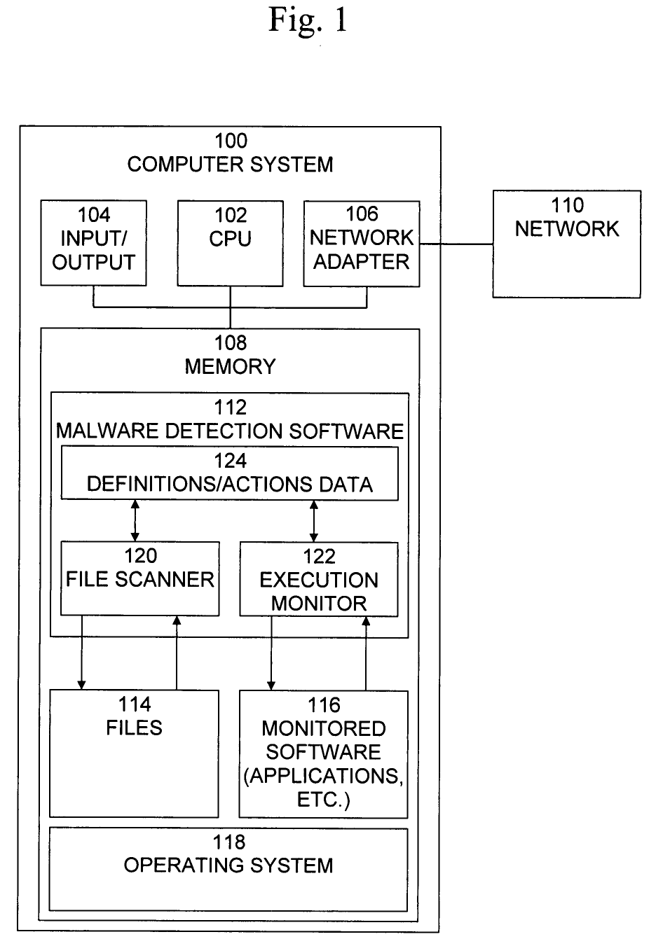

An example of a computer system 100, in which malware detection software is used to detect covert or unexpected installations, is shown in FIG. 1. Computer system 100 is typically a programmed general-purpose computer system, such as a personal computer, workstation, server system, and minicomputer or mainframe computer. Computer system 100 includes processor (CPU) 102, input/output circuitry 104, network adapter 106, and memory 108. CPU 102 executes program instructions in order to carry out the functions of the present invention. Typically, CPU 102 is a microprocessor, such as an INTEL PENTIUM® processor, but may also be a minicomputer or mainframe computer processor. Although in the example shown in FIG. 1, computer system 100 is a single processor computer system, the present invention contemplates implementation on a system or systems that provide multi-processor, multi-tasking, multi-process, multi-thread computing, distributed computing, and/or networked computing, as well as implementation on systems that provide only single processor, single thread computing. Likewise, the present invention also contemplates embodiments that utilize a distributed implementation, in which computer system 100 is implemented on a plurality of networked computer systems, which may be single-processor computer systems, multi-processor computer systems, or a mix thereof.

Input/output circuitry 104 provides the capability to input data to, or output data from, computer system 100. For example, input/output circuitry may include input devices, such as keyboards, mice, touchpads, trackballs, scanners, etc., output devices, such as video adapters, monitors, printers, etc., and input/output devices, such as, modems, etc. Network adapter 106 interfaces computer system 100 with network 110. Network 110 may be any standard local area network (LAN) or wide area network (WAN), such as Ethernet, Token Ring, the Internet, or a private or proprietary LAN/WAN.

Memory 108 stores program instructions that are executed by, and data that are used and processed by, CPU 102 to perform the functions of the present invention. Memory 108 may include electronic memory devices, such as random-access memory (RAM), read-only memory (ROM), programmable read-only memory (PROM), electrically erasable programmable read-only memory (EEPROM), flash memory, etc., and electro-mechanical memory, such as magnetic disk drives, tape drives, optical disk drives, etc., which may use an integrated drive electronics (IDE) interface, or a variation or enhancement thereof, such as enhanced IDE (EIDE) or ultra direct memory access (UDMA), or a small computer system interface (SCSI) based interface, or a variation or enhancement thereof, such as fast-SCSI, wide-SCSI, fast and wide-SCSI, etc, or a fiber channel-arbitrated loop (FC-AL) interface.

In this example, memory 108 includes malware detection software 112, files 114, monitored software 116, and operating system 118. Malware detection software 112 includes file scanning routines 120 and execution monitor 122, definitions/actions data 124, as well as other items that are not shown, such as virus removal routines, virus removal instructions, etc. Malware detection software 112 scans files 114 using file scanning routines 120 until an infected file, such as a virus, is found. Malware detection software 112 may then use virus removal routines to remove instances of the virus from infected file. Execution monitor 122 monitors the execution of software that is running in computer system 100, such as applications, processes, controls, installers, etc. Execution monitor 122 detects various states of execution of the monitored software. In particular, execution monitor detects the execution of an installer, examines data about the installer, and determines action to take as a result. Both file scanning routines 120 and execution monitor 122 use definitions/actions data 124 to determine which files and executing software routines are to be detected, and what actions to take upon detection. Operating system 112 provides overall system functionality.

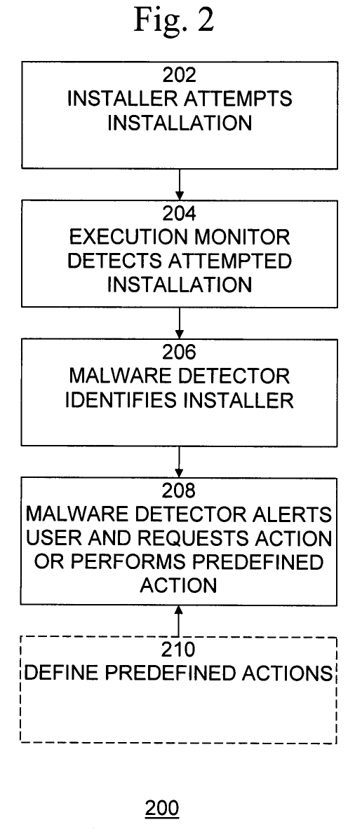

An exemplary block diagram of a process of operation 200 of the present invention is shown in FIG. 2. It is best viewed in conjunction with FIG. 1. Process 200 begins with step 202, in which an installer attempts an installation. In step 204, execution monitor 122 detects the execution of the installer and accesses definitions/actions data 124 to determine a response.

In step 206, malware detection software 112 identifies the installer. Malware detection software 112 normally includes the capability to identify the file type of software that is executing on computer system 100. However, malware detection software 112 normally acts upon software that it identifies as malware and does not act on legitimate software. The present invention draws on the file type identification capabilities of malware detection software 112, but adds the capability to detect any installer that tries to execute and provide the user with a configurable warning. Each installation package normally contains data about the package to be installed, e.g. YAHOO® toolbar, QUICKTIME®, COMET CURSORS® etc. Using this data, malware detection software 112 determines that the executable is a particular installer or belongs to a family of installers.

In step 208, malware detection software 112 may alert the user to the attempted installation and requests user input as to the action to perform, or malware detection software 112 may perform predefined actions. The information analyzed in this step may include information relating to the attempted installation, such as the installer package, the family of installer packages to which the installer package belongs, installer header data, links the installer package may make, data identifying the software that was attempted to be installed, links the software that was attempted to be installed would make if it were installed, etc. In addition, malware detection software 112 identifies nested installers, i.e., when an installer contains one or more other installers, which, once installed, would install additional software. Malware detection software 112 may alert the user of any or all of this information and may request user input as to the action to take. Likewise, malware detection software 112 may itself analyze this information and select one or more predefined actions to take. The actions to be taken may include aborting the installation, allowing the installation, allowing part of the installation and blocking part of the installation (if applicable), etc.

In step 210, which is optional, the user may be provided with the opportunity to selecting an installer or package, or a family of installers or packages, and to define one or more automatic actions to apply to any package that attempts to install such a product. Data is pulled from the header of the installer and a heuristic engine looks for clues to any links the application would make once installed.

In order to define the predefined actions to be taken, malware detection software 112 may analyze information relating to the attempted installation, such as the installer package, the family of installer packages to which the installer package belongs, installer header data, links the installer may make, the software that was attempted to be installed, links the software that was attempted to be installed would make if it were installed, etc. Malware detection software 112, may also determine the context of the installation attempt, such as whether it was performed with user interaction, silently, secondary to another installer, or remotely.

Based on this data the user can pre-determine an action to take should that package try to install.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include storage media, examples of which include, but are not limited to, floppy disks, hard disk drives, CD-ROMs, DVD-ROMs, RAM, and, flash memory, as well as transmission media, examples of which include, but are not limited to, digital and analog communications links.

Although specific embodiments of the present invention have been described, it will be understood by those of skill in the art that there are other embodiments that are equivalent to the described embodiments. Accordingly, it is to be understood that the invention is not to be limited by the specific illustrated embodiments, but only by the scope of the appended claims.

What is claimed is:

1. A method of controlling installation of software in a computer system comprising:
detecting an attempt to install software on the computer system;
identifying the software that was attempted to be installed; and
taking an action in response to identifying the software that was attempted to be installed.

2. The method of claim 1, wherein the attempt to install software on the computer system is detected using malware detection software.

3. The method of claim 2, wherein the malware detection software is modified or configured to detect the attempt to install software on the computer system.

4. The method of claim 1, wherein the software that was attempted to be installed is identified by analyzing information relating to the attempted installation.

5. The method of claim 4, wherein the analyzed information comprises at least one of: an installer package, a family of installer packages to which the installer package belongs, installer header data, links the installer package may make, data identifying the software that was attempted to be installed, and links the software that was attempted to be installed would make if it were installed.

6. The method of claim 1, wherein the action taken in response to identifying the software that was attempted to be installed comprises:
notifying a user of the computer system of the attempt to install software on the computer system; and
accepting from the user of the computer system input indicating further action to be taken.

7. The method of claim 6, wherein the further action to be taken comprises aborting the installation, allowing the installation, or allowing part of the installation and blocking part of the installation.

8. The method of claim 1, wherein the action taken in response to identifying the software that was attempted to be installed comprises taking at least one predefined action.

9. The method of claim 8, wherein the predefined action to be taken comprises aborting the installation, allowing the installation, or allowing part of the installation and blocking part of the installation.

10. A computer program product for controlling installation of software in a computer system comprising:
a computer readable storage medium;
computer program instructions, recorded on the computer readable storage medium, executable by a processor, for performing the steps of
detecting an attempt to install software on the computer system;
identifying the software that was attempted to be installed; and
taking an action in response to identifying the software that was attempted to be installed.

11. The computer program product of claim 10, wherein the attempt to install software on the computer system is detected using malware detection software.

12. The computer program product of claim 1 1, wherein the malware detection software is modified or configured to detect the attempt to install software on the computer system.

13. The computer program product of claim 10, wherein the software that was attempted to be installed is identified by analyzing information relating to the attempted installation.

14. The computer program product of claim 13, wherein the analyzed information comprises at least one of:
an installer package, a family of installer packages to which the installer package belongs, installer header data, links the installer package may make, data identifying the software that was attempted to be installed, and links the software that was attempted to be installed would make if it were installed.

15. The computer program product of claim 10, wherein the action taken in response to identifying the software that was attempted to be installed comprises:
notifying a user of the computer system of the attempt to install software on the computer system; and
accepting from the user of the computer system input indicating further action to be taken.

16. The computer program product of claim 15, wherein the further action to be taken comprises aborting the installation, allowing the installation, or allowing part of the installation and blocking part of the installation.

17. The computer program product of claim 10, wherein the action taken in response to identifying the software that was attempted to be installed comprises taking at least one predefined action.

18. The computer program product of claim 17, wherein the predefined action to be taken comprises aborting the installation, allowing the installation, or allowing part of the installation and blocking part of the installation.
